(19) United States
(12) Patent Application Publication
(10) Pub. No.: US 2014/0227609 A1
(43) Pub. Date: Aug. 14, 2014

(54) ARCHITECTURES FOR SOLID STATE BATTERIES

(71) Applicant: ITN ENERGY SYSTEMS, INC., Littleton, CO (US)

(72) Inventors: Jonathan FREY, Denver, CO (US); Brian Spencer BERLAND, Morrison, CO (US)

(21) Appl. No.: 14/343,587

(22) PCT Filed: Sep. 21, 2012
(86) PCT No.: PCT/US2012/056685

§ 371 Date: Mar. 7, 2014

Related U.S. Application Data
(60) Provisional application No. 61/537,475, filed on Sep. 21, 2011.

(51) Int. Cl. H01M 6/40; H01M 4/04; H01M 6/18; H01M 4/485; H01M 4/58

(52) U.S. Cl. CPC H01M 6/40; H01M 4/485; H01M 4/5825; H01M 6/185; H01M 4/0402
USPC 429/322; 429/233; 429/245; 429/231.3; 429/224; 429/221; 29/623.5

(57) ABSTRACT

Thin-film solid state batteries architectures and methods of manufacture are provided. Architectures include solid-state batteries with one or more cathodes, electrolytes, anodes deposited onto a substrate. Architectures may be used for solid state lithium batteries. The various fabrication techniques may be used to create a solid state battery is millimeters thick or smaller. These thin-film batteries may be small, light, and have a high energy density.

This application is being filed on 21 Sep. 2012, as a PCT International patent application, and claims priority to U.S. Provisional Patent Application No. 61/537,475, filed Sep. 21, 2011, the disclosure of which is hereby incorporated by reference herein in its entirety.

### INTRODUCTION

Solid state batteries, such as solid state lithium batteries (SSLB), are used in a variety of applications such as but not limited to consumer electronics, medical devices, and vehicle technologies. Solid state batteries have the advantage of being composed of solid materials, and therefore can operate in varied conditions such as any physical orientation and within a large temperature range. Through various fabrication techniques it is possible to make a solid state battery composed of thin materials, some only nanometers or micrometers thick, to form a finished battery that can be millimeters thick, or smaller. These solid state batteries are referred to as thin film batteries. Thin film batteries are often monolithically integrated, meaning they are manufactured by the patterned diffusion of elements into the surface of a thin substrate. Thin film batteries are desired because of their size, they are small and can be used in a variety of devices, and their weight, they are light and have a high energy density. Further, thin film batteries can be flexible based on the substrate on which they are deposited.

When using batteries a critical metric is energy density. Energy density is the amount of energy that can be used, relative to the amount of space or weight needed to contain said energy. A higher energy density is usually desired. This can be accomplished by reducing the amount of materials not actively involved in the battery, such as the substrate or other materials present for the structural integrity of the battery.

### BRIEF DESCRIPTION OF THE DRAWINGS

Non-limiting and non-exhaustive embodiments are described with reference to the following figures:

FIG. 1 illustrates an embodiment of a single-sided, SSLB.

FIG. 2 illustrates an embodiment of a double-sided, parallel-configured, SSLB.

FIG. 3 illustrates an embodiment of a stack-configured, double-sided, SSLB.

FIG. 4 illustrates an embodiment of a single-sided SSLB.

FIG. 5 illustrates an embodiment of a single-sided, multiple SSLB structure configured with a common cathode.

FIG. 6 illustrates an embodiment of a single-sided, multiple SSLB structure configured with a common anode.

FIG. 7 illustrates an embodiment of a stack-configured, single-sided SSLB connected in series.

FIG. 8 illustrates an embodiment of a single-sided SSLB.

FIG. 9 illustrates an embodiment of a stack-configured, single-sided SSLB.

FIG. 10 illustrates an embodiment of a single-sided, series connected, monolithically integrated SSLB.

FIG. 11 illustrates an embodiment of a single-sided, parallel connected, monolithically integrated SSLB.

FIG. 12 illustrates an embodiment of a double-sided, series and parallel connected, monolithically integrated SSLB.

FIG. 13 illustrates an embodiment of a double-sided, series connected, monolithically integrated SSLB.

FIG. 14 illustrates an embodiment of a method of roll-to-roll manufacture of a single-sided, series connected or parallel connected, monolithically integrated SSLB.

FIG. 15 illustrates an embodiment of a first step of a method for fabricating SSLBs.

FIG. 16 illustrates an embodiment of a second step of a method for fabricating SSLBs.

FIG. 17 illustrates an embodiment of a third step of a method for fabricating SSLBs.

FIG. 18 illustrates an embodiment of a fourth step of a method for fabricating SSLBs.

FIG. 19 illustrates an embodiment of a fifth step of a method for fabricating SSLBs.

FIG. 20 illustrates an embodiment of a completed parallel connected SSLB.

### DETAILED DESCRIPTION

With the architectures and methods disclosed herein for monolithically integrated solid state thin film batteries, flexible batteries with a high energy density can be fabricated. The drawings illustrate various embodiments with a stepwise progression towards more complicated battery architectures. The architectures described are designed to maximize energy density while maintaining flexibility and the desired electrical characteristics.

Monolithic integration of thin film batteries involves the electrical interconnection of multiple individual batteries through the creation of specific structures such as conductive vias, or insulating isolation trenches. As used herein, etching (i.e. chemical), drilling (i.e. mechanical), and scribing (i.e. laser) are considered interchangeable processes and are not to be taken as limiting.

Various embodiments are described more fully below with reference to the accompanying drawings, which are a part of this application, and which show specific example embodiments. However, embodiments may be implemented in many different forms and should not be construed as limited to the embodiments set forth herein; rather, these embodiments are provided so that this disclosure will be thorough and complete in the presentation of the functional concepts, and will fully convey the scope of the embodiments to those skilled in the art. The following detailed description is, therefore, not to be taken in a limiting sense.

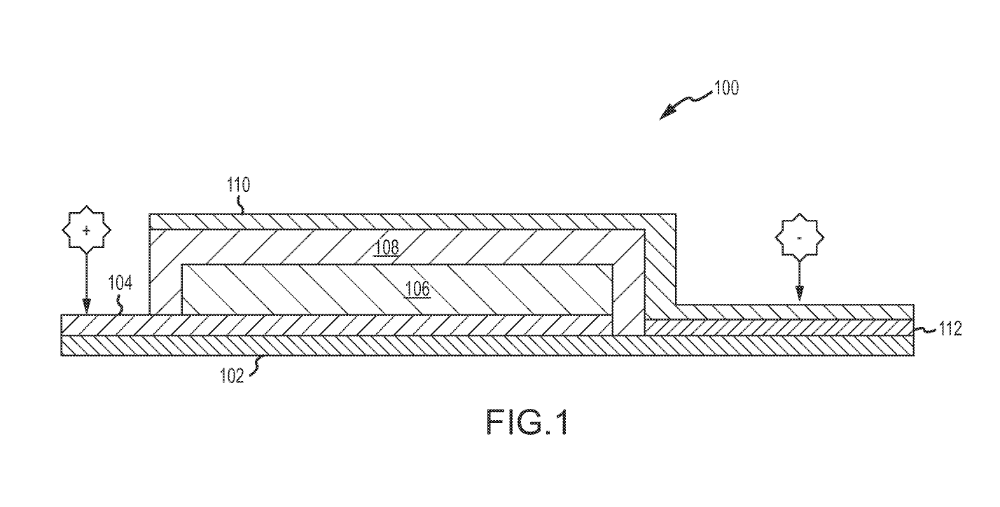

One embodiment of a single-sided, SSLB is illustrated in FIG. 1. The battery 100 is a layered structure deposited on a substrate 102, which can be both flexible and rigid. In one embodiment the substrate 102 is polyethylene terephthalate (PET). In another embodiment the substrate 102 is one of plastic, stainless foil, glass, and ceramic. The cathode contact 104, which may extend horizontally beyond the other layers, is used as a contact for the cathode 106. In one embodiment the cathode contact 104 is gold, though it can be a variety of conductive materials such as a metal or a conductive paste or ink. The cathode 106 is in direct contact with the cathode contact 104. The cathode 106 can be a variety of materials, but is often a metal oxide. The cathode 106 may be any currently known or future material suitable for use as a cathode in a thin film solid state battery. In one embodiment the cathode 106 is at least one of LiCoO₂, LiMn₂O₄, and LiFePO₄. The cathode 106 is separated from the anode 110 by an electrolyte 108. The electrolyte 108 is used to separate the cathode 106 from the anode 110, while allowing for the flow of lithium ions between the cathode 106 and the anode 110. Lithium phosphorus oxynitride (LiPON) is an amorphous polymer material that may be used as an electrolyte 108, though any currently known or future material suitable for use as an electrolyte in a thin film solid state battery may be used. An anode 110 is deposited, in this embodiment, on top of the electrolyte 108 and an anode contact 112. In some embodiments the anode 110 is lithium, or another molecule containing lithium. In various embodiments the anode 110 itself acts as the contact point 112 for the anode. In other embodiments, an anode contact 112 is used as an electrical contact point for the anode 110. In one embodiment the anode contact 112 is nickel, though it can be a variety of conductive materials such as a metal or a conductive paste or ink. It should be noted that the anode contact 112 and the cathode contact 104 are located on the same side of the substrate 102 in this embodiment. To avoid oxidation of the battery layers 100, a barrier coating may be deposited on the outside of this battery. In one embodiment, this barrier coating is aluminum oxynitride (AlON). In another embodiment the battery 100 is vacuum sealed to avoid possible reactions with air.

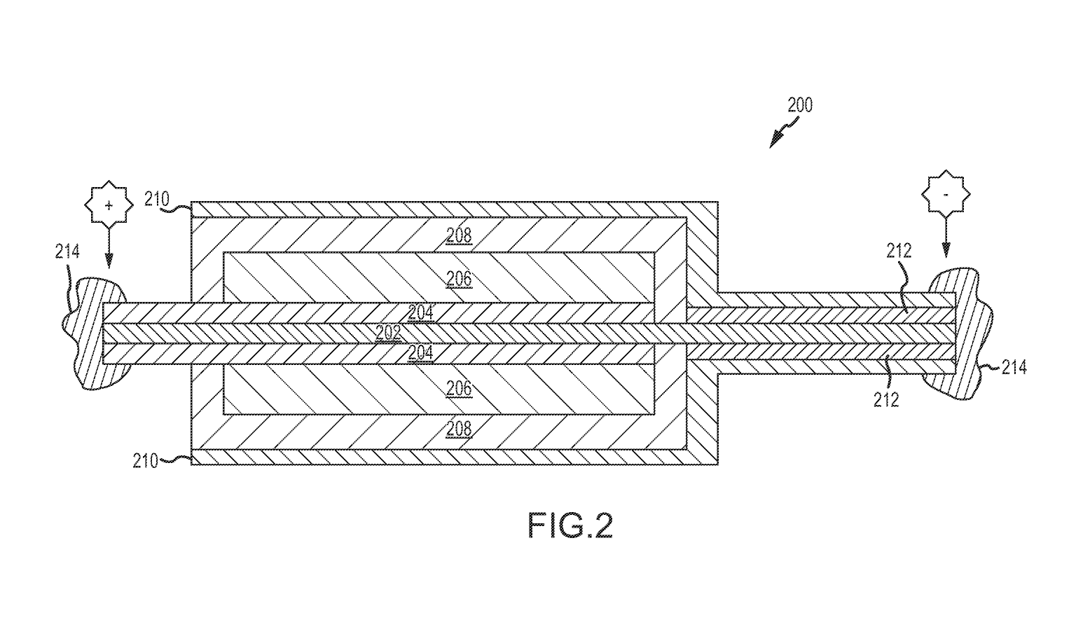

An embodiment of a double-sided, parallel-configured, solid state lithium battery is illustrated in FIG. 2. The two batteries 200 are located on opposite sides of a substrate 202. The cathode contacts 204 of the two batteries are soldered 214 together, or electrically connected in a similar and/or equivalent manner, as are the anode contacts 212 of the two batteries 200. This creates a parallel connection for the two batteries 200. Energy density is increased relative to the example battery in FIG. 1 because a common substrate 202 is used between the two batteries 200. This eliminates some mass that would otherwise be present (in a second substrate) and therefore increases energy density. It should be noted that the cathode contacts 204 and the anode contacts 212 can be contacted on either side of the substrate. The cathode contacts 204 and the anode contacts 212 may be contacted on the same side or opposite sides. In an embodiment, substrate 202, cathode contacts 204, cathodes 206, electrolytes 208, anodes 210, and/or anode contacts 212, are the same as or similar to previously described substrate 102, cathode contact 104, cathode 106, electrolyte 108, anode 110, and/or anode contact 112, respectively.

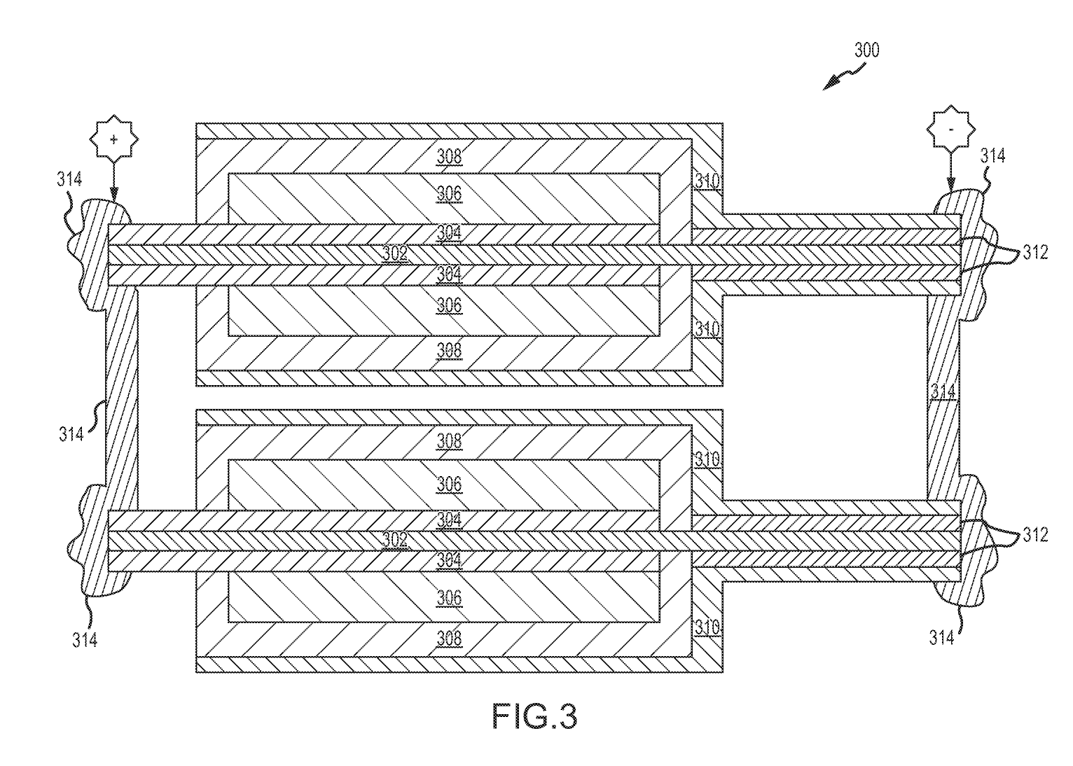

An embodiment of a stack-configured, double-sided, SSLB 300 is illustrated in FIG. 3. This embodiment connects two double sided, parallel configured, SSLBs together in parallel by stacking the batteries and soldering 314 the cathode contacts 304 and the anode contacts 312 of the first double sided, parallel configured SSLB with the cathode contacts 304 and the anode contacts 312 of the second double sided, parallel configured SSLB respectively. In an embodiment, substrates 302, cathode contacts 304, cathodes 306, electrolytes 308, anodes 310, anode contacts 312, and/or solder 314, are the same as or similar to previously described substrate 102, cathode contact 104, cathode 106, electrolyte 108, anode 110, and/or anode contact 112, respectively.

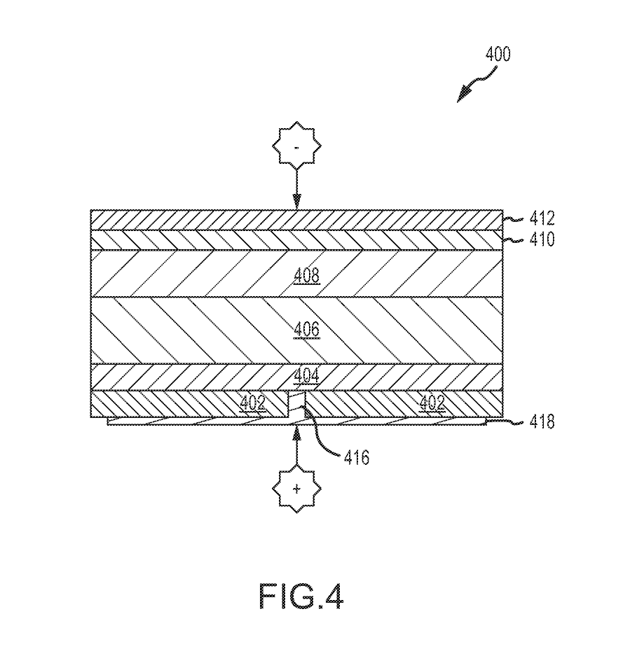

One embodiment of a single-sided SSLB is illustrated in FIG. 4. In some embodiments, the SSLB 400 is deposited in layers on a substrate 402. To contact the cathode 406, a via 416 is drilled or etched through the substrate 402 and a conductive layer 418 is deposited on the side of the substrate 402 opposite the battery. In another embodiment, a substrate 402 is used with a conductive layer 418 already present on one side, and vias 416 are etched or drilled through the substrate 402 but not through the conductive layer 418. The vias 416 can then be filled with a conductive paste or with the cathode contact 404 to establish contact with the conductive layer 418. The via 416 may be drilled or etched in any suitable manner such as but not limited to by laser. By contacting the cathode 406 through a laser-drilled via 416 the fabrication can be easier when compared to the embodiment illustrated in FIG. 1 because layers may be deposited on an equal area, whereas the cathode contact 104 of the embodiment illustrated in FIG.1 must extend beyond the other layers to enable contact to be made. Also, when contacting the cathode 406 through a laser-drilled via, a large battery can be fabricated and then post processed to form many smaller functional batteries. It should be noted the cathode contact 404, which is connected to and contacted by the conductive layer 418, and the anode contact 412 are located on opposite sides of the substrate 402 in this embodiment. In an embodiment, substrate 402, cathode contact 404, cathode 406, electrolyte 408, anode 410, and/or anode contact 412, are the same as or similar to previously described substrate 102, cathode contact 104, cathode 106, electrolyte 108, anode 110, and/or anode contact 112, respectively.

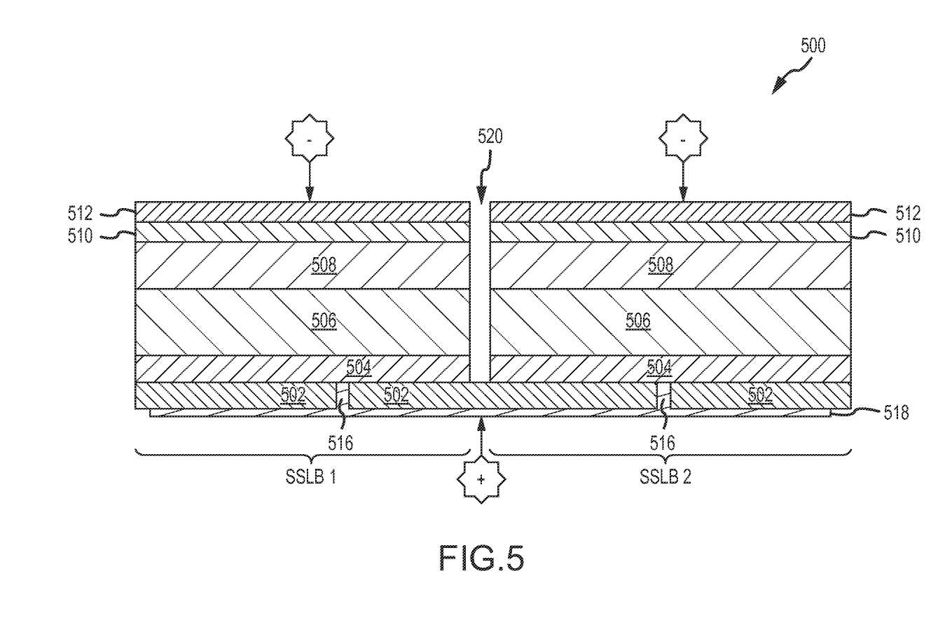

One embodiment of a single-sided, multiple SSLB structure 500 configured with a common cathode is illustrated in FIG. 5. As illustrated, it is possible for multiple batteries to be fabricated on a substrate 502 and then connected by a common conductive layer 518 connected to the cathode contact 504 of each battery by drilling vias 516 through the substrate 502 to contact each cathode 504, and then depositing a conductive layer 518 on the substrate 502 opposite the battery. In another embodiment, a large battery could be fabricated and then etched or drilled 520 to isolate the anodes 510 and anode contacts 512 of each battery. It should be noted that in this embodiment the conductive layer 518 connected to the one cathode 506 is on the opposite side of the substrate 502 from the plurality of anodes 510. In an embodiment, substrate 502, cathode contact 504, cathode 506, electrolyte 508, anode 510, anode contact 512, via 516, and/or conductive layer 518, are the same as or similar to previously described substrate 102, cathode contact 104, cathode 106, electrolyte 108, anode 110, and/or anode contact 112, respectively.

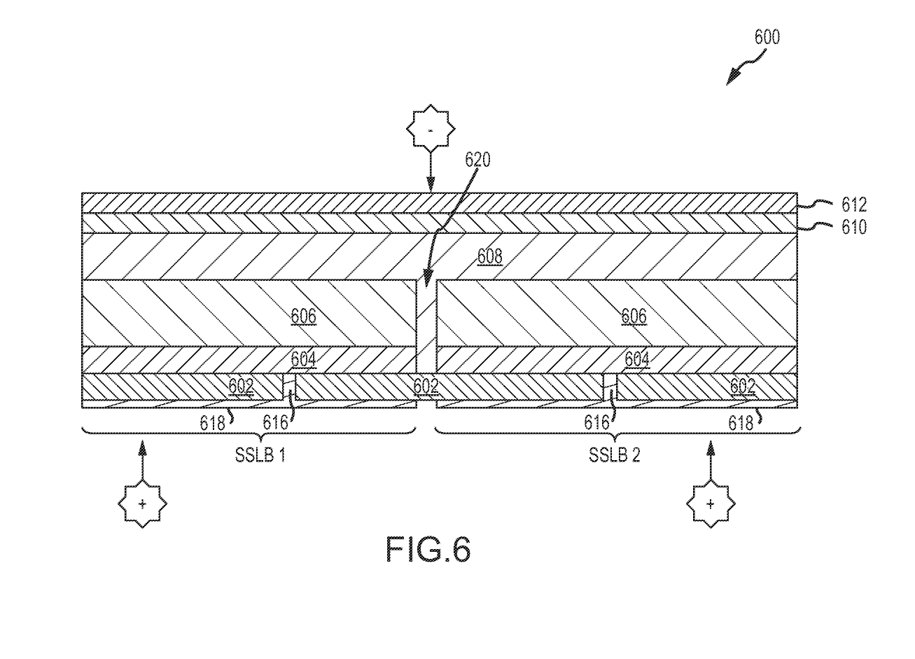

An embodiment of a single-sided, multiple SSLB structure 600 configured with a common anode is illustrated in FIG. 6. As illustrated, a common anode 612 is possible by separating the cathode 606 and cathode contact 604 of different batteries from each other by depositing an electrolyte 608 between them. In one embodiment, as illustrated, contact is established with the cathode contacts 604 by laser-drilling vias 616 through the substrate 602 and depositing a conductive material 618 on the opposite side of the substrate 602 as the batteries. In the embodiment shown, the conductive material 618 is deposited on an area local to the via 616, and does not overlap with the conductive material 618 deposited around other vias 616. This conductive material 618 deposition forms separate contact points for each of the cathodes 604. Further, the electrolyte 608 is deposited as a layer across the entire structure and even between the cathodes 606 and cathode contacts 604 of different batteries. The anode 610 and anode contact 612 are deposited as a layer across the top of the entire structure. The depositing of the anode 610 and anode contact 612 creates a common anode 610 and anode contact 612 across all of the batteries in the structure 600. It should be noted that the contact for the plurality of cathodes 606 is made with a conductive layer 618 on the opposite side of the substrate 602 from the contact 612 for the anode 610. In an embodiment, substrate 602, cathode contact 604, cathode 606, electrolyte 608, anode 610 and/or anode contact 612 are the same as or similar to previously described substrate 102, cathode contact 104, cathode 106, electrolyte 108, anode 110, and anode contact 112, respectively.

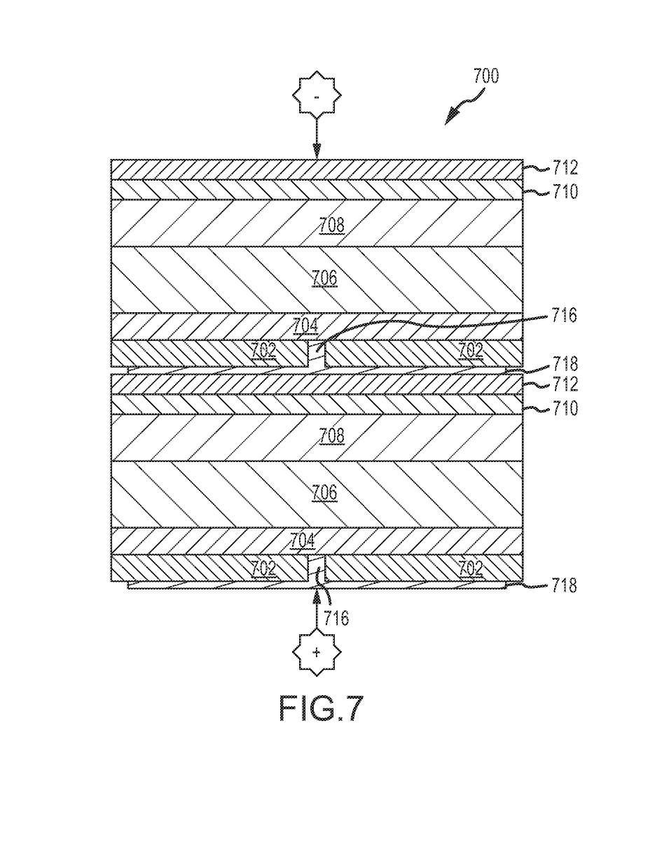

An embodiment of a stack-configured, single-sided SSLB connected in series 700 is illustrated in FIG. 7. In one embodiment, at least two batteries similar to those in FIG. 4 are fabricated with laser drilled vias 716 on the back side of the substrate 702. In some embodiments, series contact is made between the batteries by physically stacking the batteries on top of one another so the conductive region 718 in contact with the cathode 706 of one battery is electrically, and in some embodiments physically, in contact with the anode contact 712 of another battery. While total energy can be increased in this structure energy density does not substantially change from that in FIG. 4 since twice as much material is needed to potentially double the energy. It should be noted that in this embodiment, contact with the anode 712 and contact with the cathode 718 occur on opposite sides of the substrates 702 of the structure. In one embodiment a single substrate 702 is used and multiple batteries are deposited on top of one another, where the cathode contact 704 and/or cathode 706 of one battery is deposited directly on top of the anode contact 712 and/or anode 710 of the battery that was previously deposited. In another embodiment an initial substrate 702 is used upon which a battery has been deposited. Another battery is deposited on top of the first by replacing the secondary substrate, and cathode contact with a conductive metal foil. In an embodiment, substrate 702, cathode contact 704, cathode 706, electrolyte 708, anode 710, and/or anode contact 712 are the same as or similar to previously described substrate 102, cathode contact 104, cathode 106, electrolyte 108, anode 110, and/or anode contact 112, respectively.

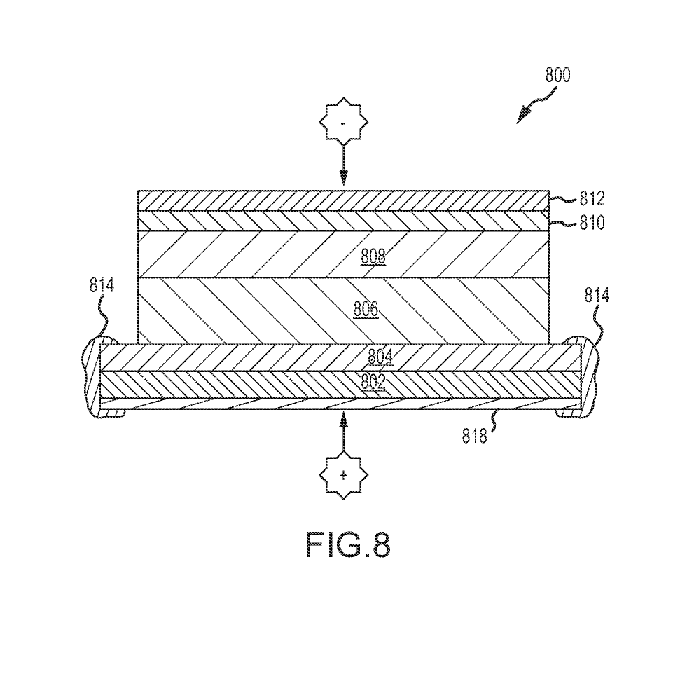

One embodiment of a single-sided SSLB 800 is illustrated in FIG. 8. In this embodiment the various layers of the structure 800 are deposited uniformly across the substrate 802. Also, a conductive layer 818 is deposited on the side of the substrate 802 opposite the battery. In the embodiment shown, contact is made between the conductive layer 818 deposited on the back side of the substrate 802 and the cathode 806 and/or cathode contact 804 by soldering 814 them together around the edge of the substrate 802. It should be noted that in this embodiment, contact with the cathode 806 and/or cathode contact 804 and the anode 810 and/or anode contact 812 can be made on the same and/or opposite sides of the substrate 802. In an embodiment, substrate 802, cathode contact 804, cathode 806, electrolyte 808, anode 810, and/or anode contact 812 are the same as or similar to previously described substrate 102, cathode contact 104, cathode 106, electrolyte 108, anode 110, and/or anode contact 112, respectively.

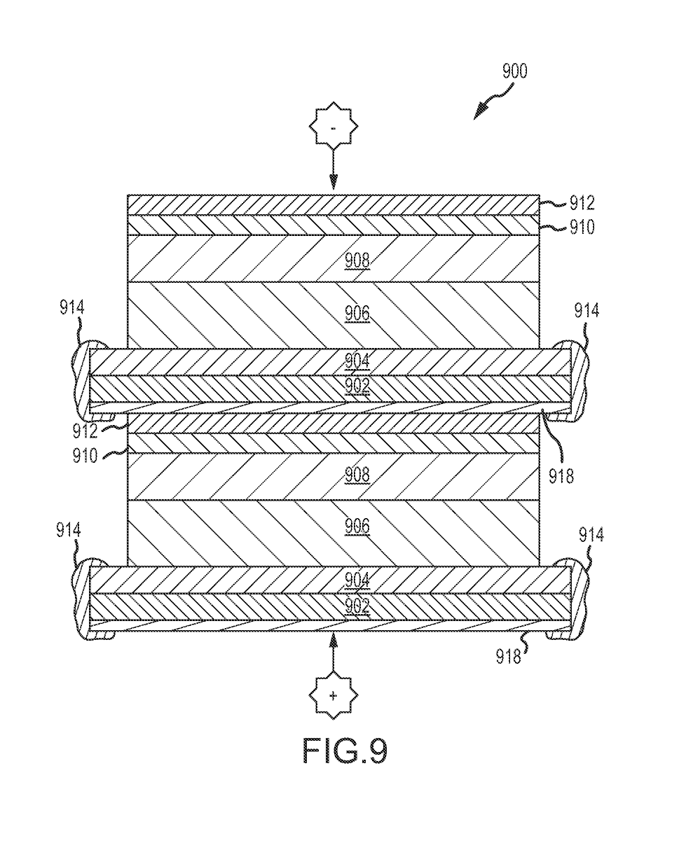

One embodiment of a stack-configured, single-sided SSLB 900 is illustrated in FIG. 9. In this embodiment, a conductive layer 918 is deposited on the back side of the substrate 902, and contact is established with the cathode 906 and/or cathode contact 904 through soldering 914 around the edge of the substrate 902. In this embodiment, two batteries, such as those illustrated in FIG. 8 are connected in series by stacking the conductive layer 918 in contact with the cathode 906 and/or cathode contact 904 of one battery on the anode contact 912 of another battery. It should be noted that in this embodiment, contact with the anode 912 and the cathode 918 are located on opposite sides of one of the substrates 902. In an embodiment, substrate 902, cathode contact 904, cathode 906, electrolyte 908, anode 910, and/or anode contact 912 are the same as or similar to previously described substrate 102, cathode contact 104, cathode 106, electrolyte 108, anode 110, and/or anode contact 112, respectively.

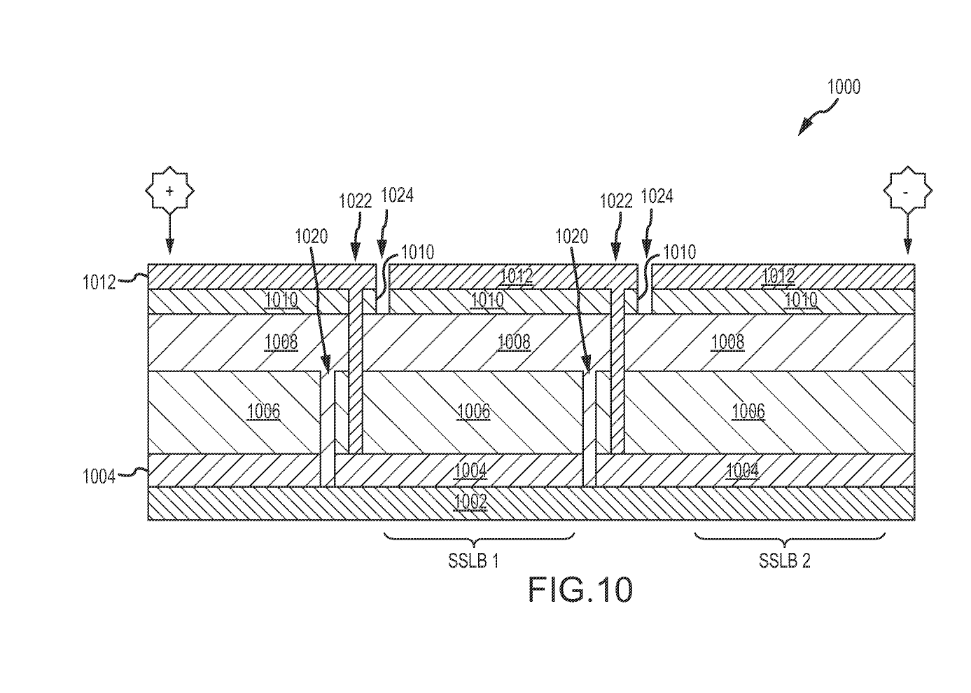

An embodiment of a single-sided, series connected, monolithically integrated SSLB 1000 is illustrated in FIG. 10. In this embodiment uniform layers are deposited across a substrate 1002. Between deposition layers, structures 1020, 1022, and 1024 are etched into the previous layers to establish the architecture of the battery 1000. In some embodiments, standard P1/P2/P3 etching is used to establish isolation between a first cathode 1006 and a second cathode 1006, between cathode 1006 and anode 1010, and between a first anode 1010 and a second anode 1010. Also the etching is used to establish a connection between the anode 1010 of one battery and the cathode 1006 of the next battery in series. As illustrated in this embodiment, the first etch (P1) 1020 on the left side occurs after the cathode contact 1004 and cathode 1006 have been deposited on the substrate 1002, and the P1 etch 1020 etches these two layers while leaving the substrate 1002 relatively unaffected. The P1 etch 1020 is filled with the electrolyte 1008 when the next layer is deposited. The P1 etch 1020 isolates a first cathode 1006 and/or first cathode contact 1004 of one battery from a second cathode 1006 and/or second cathode contact 1004 of another battery. Continuing to the right in the illustration, the second etch (P2) 1022 occurs after the electrolyte 1008 and the anode 1010 have been deposited. The P2 etch 1022 serves to further isolate a first cathode 1006 of one battery from a second cathode 1006 of another battery. Further, the P2 etch 1022 allows a first anode contact 1012, after it has been deposited, to contact a second cathode contact 1004 of the next battery in series. Additionally, the P1 etch 1020 prevents the cathode 1006 and/or cathode contact 1004 from contacting the P2 etch 1022 after the anode contact 1012 is deposited, and therefore contacting the anode contact 1012, which would short out one of the batteries. The third etch (P3) 1024 is performed after all of the layers have been deposited, and it etches the anode contact 1012 layer as well as the anode 1010 layer. This isolates the anodes 1010 of each of the batteries. The result of this P1/P2/P3 (1020/1022/1024) etching process is multiple batteries deposited on the same substrate 1002 at the same time that are all connected to one another in series. In this embodiment, the first cathode contact 1004, first cathode 1006, and first electrolyte 1008 on the left end of the structure 1000 before the P1 etch 1020 occurs do not actually form a battery since there is no contact point for the first cathode 1006. Because there is no contact point for the first cathode 1006 on the left end of the structure 1000, the first anode contact 1012 on the left edge of the structure 1000 serves as the point of contact for a second cathode contact 1004 since the second cathode contact 1004 is the only thing in electrical contact with the first anode contact 1012. It should be noted that in this embodiment the contact point for the cathode contact 1004, or the first anode contact 1012, and the third anode contact 1012 are contacted on the same side of the substrate 1002. In an embodiment, substrate 1002, cathode contact 1004, cathode 1006, electrolyte 1008, anode 1010, and/or anode contact 1012 are the same as or similar to previously described substrate 102, cathode contact 104, cathode 106, electrolyte 108, anode 110, and/or anode contact 112, respectively.

In another embodiment (not shown), vias are drilled through the back side of the substrate and a conductive material is deposited thereon. The conductive material can then be used as a point of contact for the cathode, assuming the vias are drilled through the substrate to the cathode contact, similar to the via 416 illustrated in FIG. 4. In this embodiment, the cathode, cathode contact, and electrolyte on the edge of the structure would be actively used in the battery since the cathode contact would be used as a contact point. Furthermore contact for the cathode and contact for the anode occur on opposite sides of the substrate.

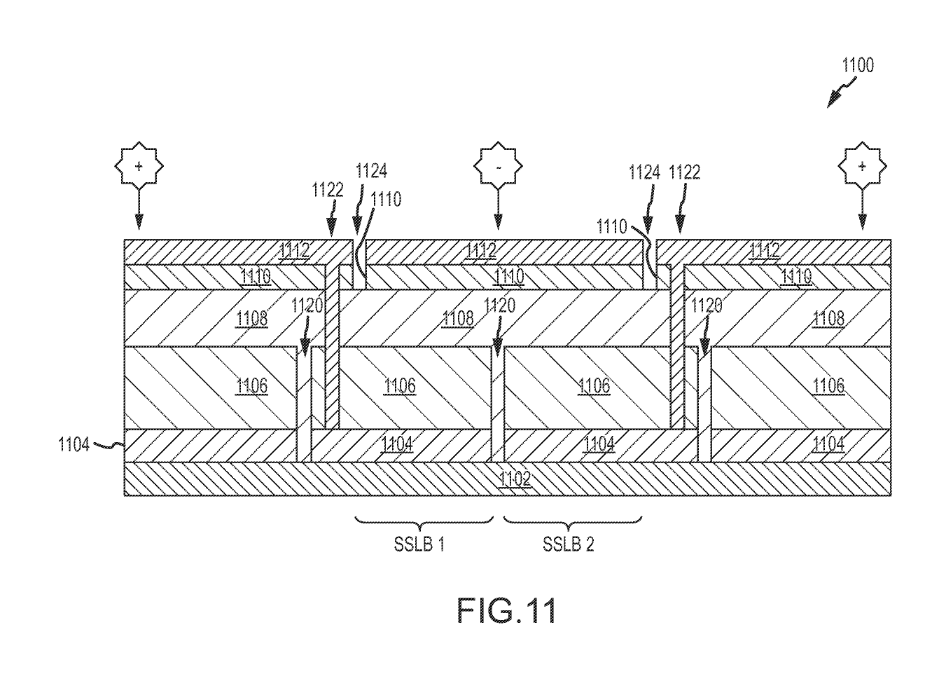

An embodiment of a single-sided, parallel connected, monolithically integrated SSLB 1100 is illustrated in FIG. 11. Similar P1/P2/P3 (1120/1122/1124) etches are used as in FIG. 10 with an additional P1 etch 1120 included (see additional P1 etch between SSLB1 and SSLB2). This additional P1 etch 1120 without the P2 1122 and P3 1124 etches creates batteries that are connected in parallel. Further, on the opposite side of the additional P1 etch 1120 from the original P1/P2/P3 etches 1120/1122/1124, the order is reversed and P3/P2/P1 etches 1124/1122/1120 are utilized. In this embodiment, the cathode contact 1104, cathode 1106, and electrolyte 1108 on both edges of the structure 1100 are not involved in a battery because there is no contact point for the cathode 1106. In another embodiment, two or more sets of series connected batteries similar to the one seen in FIG. 10 can be connected in parallel in a manner similar to that seen in FIG. 11. It should be noted that this embodiment contains triple point contacting, all of which are located on the same side of the substrate. There is a different positive contact for each of the parallel branches, and one negative contact that is responsible for both of the parallel branches. In another embodiment (not shown), vias are drilled through the back side of the substrate and a conductive material is deposited thereon. The conductive material can then be used as a point of contact for the cathodes, assuming the vias are drilled through the substrate to the cathode contact, similar to the via 416 illustrated in FIG. 4. In this embodiment, the cathode contact, cathode, and electrolyte on both edges of the structure can be utilized in the battery since the cathode contact can be contacted. Furthermore contact for the cathode and contact for the anode occur on opposite sides of the substrate. In an embodiment, substrate 1102, cathode contact 1104, cathode 1106, electrolyte 1108, anode 1110, anode contact 1112, P1 etch 1120, P2 etch 1122, and/or P3 etch 1124, are the same as or similar to previously described substrate 102, cathode contact 104, cathode 106, electrolyte 108, anode 110, anode contact 112, P1 etch 1020, P2 etch 1022, and/or P3 etch 1024, respectively.

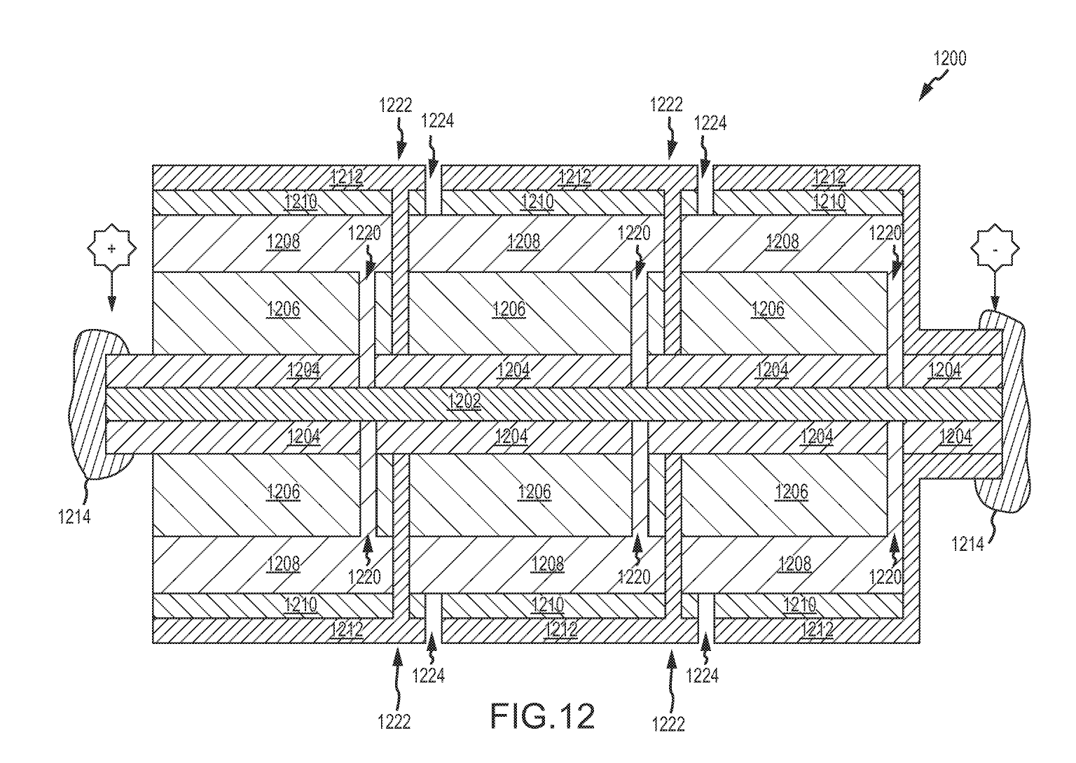

One embodiment of a double-sided, series and parallel connected, monolithically integrated SSLB 1200 is illustrated in FIG. 12. In this embodiment a series connected, monolithically integrated, SSLB is fabricated similar to the embodiment illustrated in FIG. 10, but is fabricated on both sides of the substrate 1202. It should be noted that in this embodiment the series connected battery fabricated on the back side of the substrate 1202 mirrors the battery fabricated on the front side. In some embodiments, both sides are patterned simultaneously. In one embodiment, the series connected batteries on either side of the substrate 1202 are connected in parallel by soldering 1214 together the cathode contacts 1204 on one end, and the anode contacts 1212 on the other. In another embodiment vias are etched or drilled through the substrate 1202 and then filled with a conductive paste or the deposited cathode contact 1204 to connect the cathode contacts 1204 on one end of the structure, and the anode contacts 1212 on the other end. In this embodiment the two contact points can be on the same side of the substrate 1202 or on opposite sides of the substrate 1202, and either or both contacts can also be on the edge of the structure 1200. In an embodiment, substrate 1202, cathode contact 1204, cathode 1206, electrolyte 1208, anode 1210, anode contact 1212, P1 etch 1220, P2 etch 1222, and/or P3 etch 1224, are the same as or similar to previously described substrate 102, cathode contact 104, cathode 106, electrolyte 108, anode 110, anode contact 112, P1 etch 1020, P2 etch 1022, and/or P3 etch 1024, respectively.

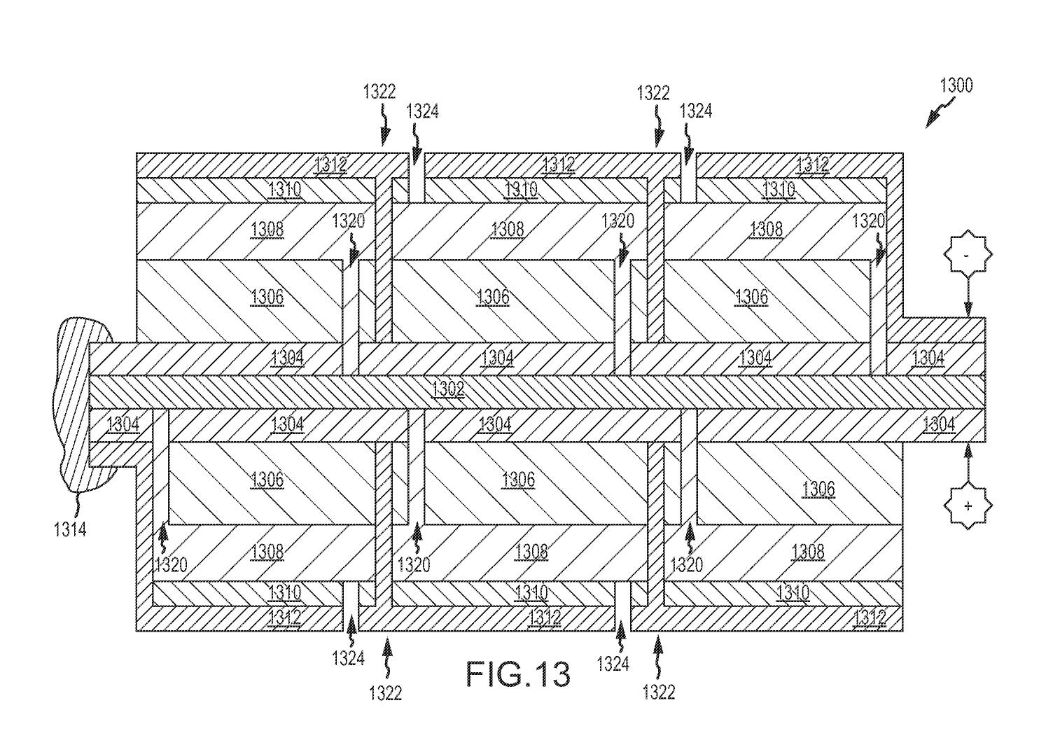

One embodiment of a double-sided, series connected, monolithically integrated SSLB 1300 is illustrated in FIG. 13. In this embodiment a series connected monolithically integrated SSLB, similar to the embodiment illustrated in FIG. 10, is deposited on both sides of the substrate 1302. Unlike the embodiment illustrated in FIG. 12, in this embodiment the batteries on each side of the substrate 1302 do not mirror each other, so the cathode contact 1304 of the battery on one side of the substrate 1302 is located across the substrate 1302 from the anode contact 1312 of the battery on the other side. In this embodiment the cathode contact 1304 and anode contact 1312 are soldered 1314 together on one end of the structure 1300, around the edge of the substrate 1302. This soldering 1314 forms a series connection of the two series connected batteries on each side of the substrate 1302. It should be noted that the end of the structure 1300 opposite the soldering 1314 is not soldered and serves as the points of contact. In some embodiments, a via (not shown) is etched or drilled through the substrate 1302 on the end opposite the points of contact and then filled with a conductive paste or the deposited cathode contact 1304 to connect a cathode contact 1304 of the batteries on one side of the substrate 1302 with an anode contact 1312 of the batteries on the opposite side of the substrate 1302. In the illustrated embodiment the point of contact is on the same edge of the structure 1300, but on opposite sides of the substrate 1302. In this embodiment the energy density can be increased greatly compared to the embodiment illustrated in FIG. 1 since one substrate 1302 is used for the plurality of batteries connected in series on both sides of the substrate 1302, this results in minimal mass associated with the substrate 1302 relative to the components and layers of the battery. In an embodiment, substrate 1302, cathode contact 1304, cathode 1306, electrolyte 1308, anode 1310, anode contact 1312, P1 etch 1320, P2 etch 1322, and/or P3 etch 1324, are the same as or similar to previously described substrate 102, cathode contact 104, cathode 106, electrolyte 108, anode 110, anode contact 112, P1 etch 1020, P2 etch 1022, and/or P3 etch 1024, respectively.

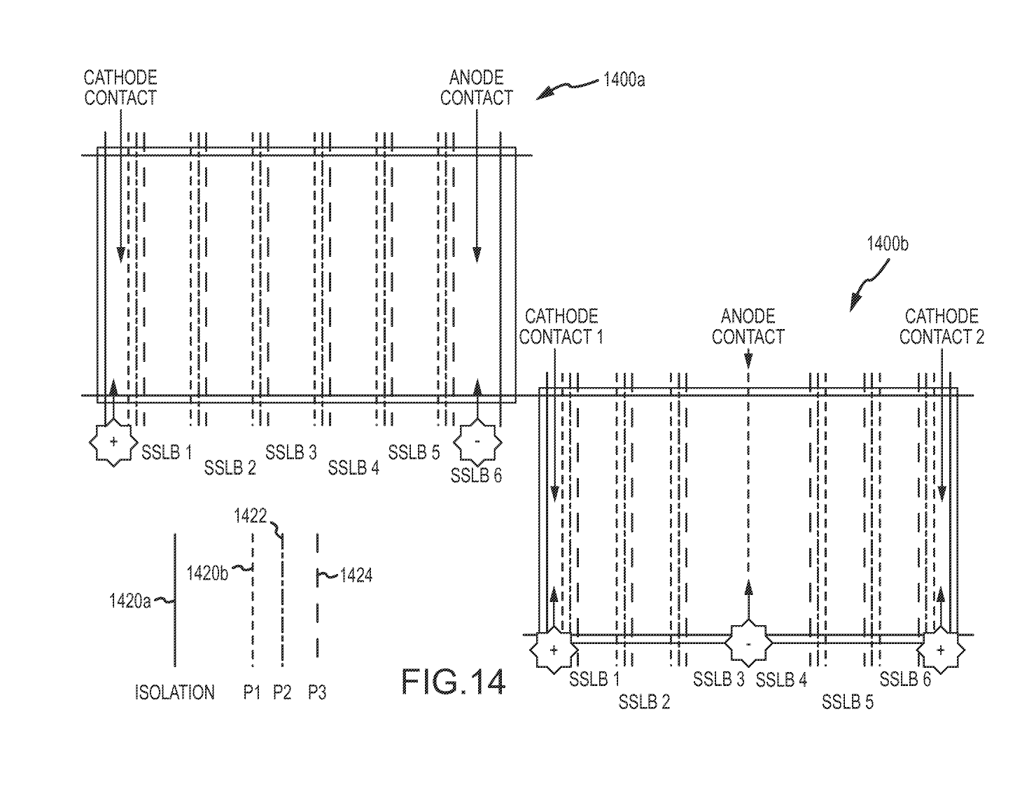

An embodiment of a method of roll-to-roll manufacture of a single-sided, series connected or parallel connected, monolithically integrated SSLB 1400 is illustrated in FIG. 14. The top view of an embodiment of a single-sided, series connected, monolithically integrated SSLB 1400a similar to the embodiment shown in FIG. 10 is shown to the left of the illustration. The top view of an embodiment of a single-sided, parallel connected, monolithically integrated SSLB 1400b similar to the embodiment shown in FIG. 11 is shown to the right of the illustration. Included in this illustration are isolation etches 1420a as well as the P1 1420b, P2 1422, and P3 1424 etches. It should be noted that the isolation etch 1420a is similar to, and in some cases the same as, the P1 etch 1420b. In an embodiment, the isolation etch 1420a differs from the P1 etch 1420b in that the isolation etch 1420a occurs after all of the active layers have been deposited on the substrate thereby isolating all of the layers. Also illustrated are positive and negative contact points for each of the battery architectures 1400a, 1400b. In one embodiment, laser scribing is used to etch the isolation etches 1420a and/or the P1/P2/P3 etches 1420b/1422/1424. In this embodiment a very high throughput can be achieved for a roll-to-roll process, in part due to the varied conditions under which a laser can operate compared to an alternate etching process. In an embodiment, roll-to-roll processing can be performed on one or two sides of the substrate, resulting in a single-sided or double-sided SSLB. The two sides of a double-sided SSLB can be deposited and/or etched in the same roll-to-roll process or in separate processes. It should be noted that the number of cells as well as the electrical configuration (series or parallel connection) can be modified to meet specific voltage and/or current guidelines. In an embodiment, P1 etch 1420, P2 etch 1422, and/or P3 etch 1424, are the same as or similar to previously described P1 etch 1020, P2 etch 1022, and/or P3 etch 1024, respectively.

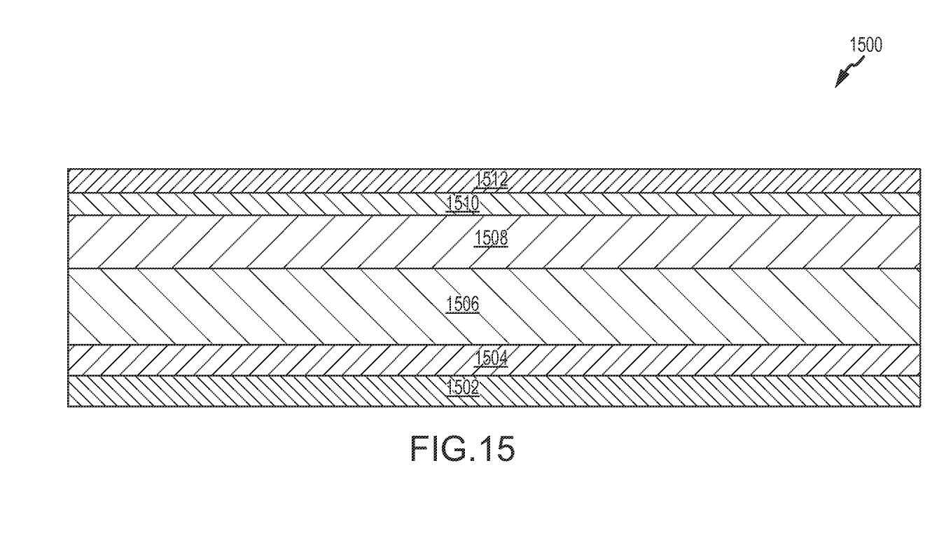

FIG. 15 illustrates an embodiment of a first step of a method for fabricating SSLBs 1500. In this embodiment the first step is to uniformly deposit the active battery layers, such as but not limited to the cathode 1506, electrolyte 1508, and anode 1510 deposited on a substrate 1502. In an embodiment, the layers include a cathode contact 1504 and an anode contact 1512. In an embodiment, substrate 1502, cathode contact 1504, cathode 1506, electrolyte 1508, anode 1510, and/or anode contact 1512, are the same as or similar to previously described substrate 102, cathode contact 104, cathode 106, electrolyte 108, anode 110, and/or anode contact 112, respectively.

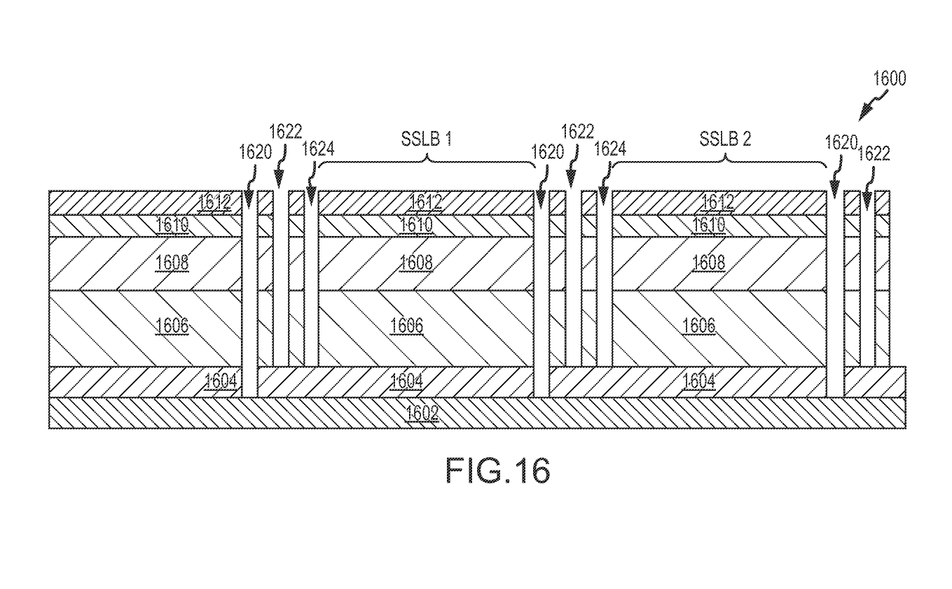

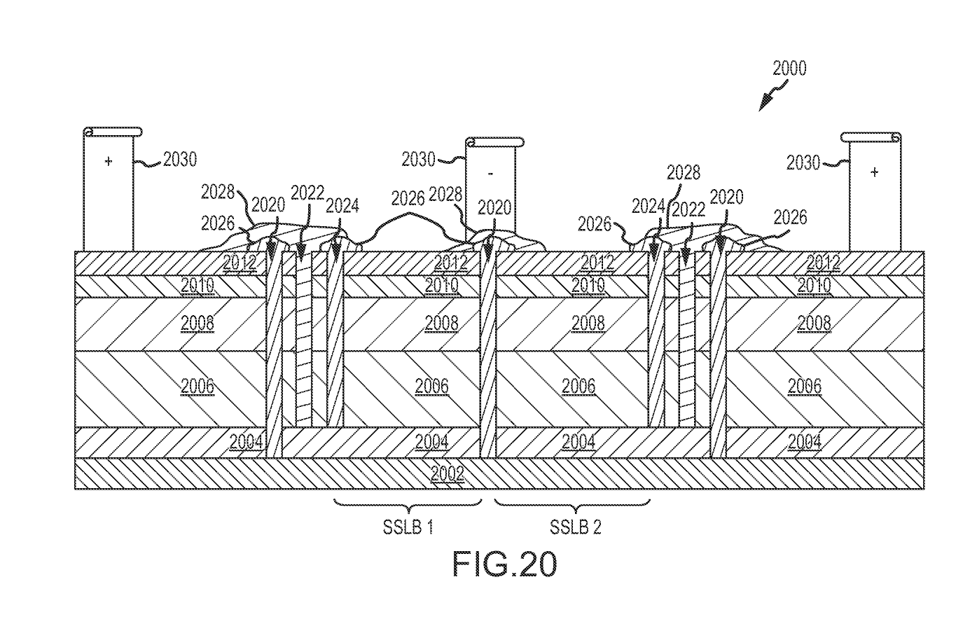

FIG. 16 illustrates an embodiment of a second step of a method for fabricating SSLBs 1600. In the second step of this embodiment P1 etch 1620, P2 etch 1622, and P3 etch 1624 are performed. In one embodiment the P1 etch 1620, P2 etch 1622, and P3 etch 1624 are scribed with a laser. The P1 etch 1620 is used to isolate batteries that are located next to each other on the substrate 1602. The P1 etch 1620 is scribed through all of the battery layers to the substrate 1602. At this step in the illustrated embodiment the P2 etch 1622 and P3 etch 1624 are very similar etches. Both the P2 etch 1622 and the P3 etch 1624 penetrate through all of the active battery layers except for the cathode 1606 and/or cathode contact 1604 such as but not limited to the anode 1610, anode contact 1612, electrolyte 1608, and cathode 1606. It should be noted that in this embodiment of a method for fabricating SSLBs a series connected SSLB is fabricated. In another embodiment a parallel connected SSLB may be fabricated by combining a plurality of P1/P2/P3 etches 1620/1622/1624 with a subsequent P1 etch 1620 followed by a plurality of P3/P2/P1 etches 1624/1622/1620, as illustrated in FIG. 11 and FIG. 20. In an embodiment, substrate 1602, cathode contact 1604, cathode 1606, electrolyte 1608, anode 1610, anode contact 1612, P1 etch 1620, P2 etch 1622, and/or P3 etch 1624, are the same as or similar to previously described substrate 102, cathode contact 104, cathode 106, electrolyte 108, anode 110, anode contact 112, P1 etch 1020, P2 etch 1022, and/or P3 etch 1024, respectively.

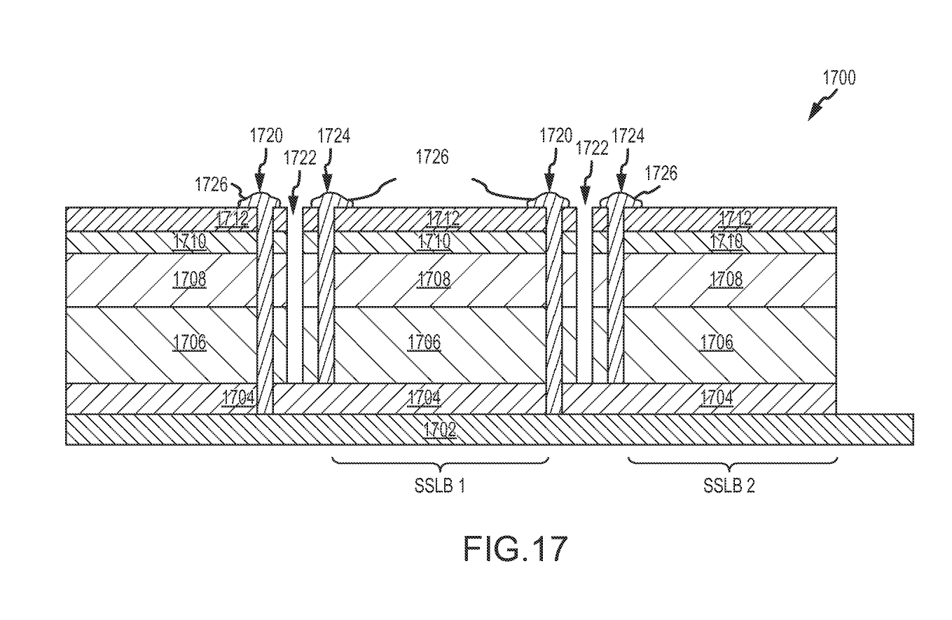

FIG. 17 illustrates an embodiment of a third step of a method for fabricating SSLBs 1700. In the third step of this embodiment the P1 etch 1720 and P3 etch 1724 are filled. In one embodiment the P1 etch 1720 and P3 etch 1724 are filled through an inkjet fill with insulating ink 1726. In another embodiment the P1 etch 1720 and P3 etch 1724 are filled through another process with a non-conductive material. The P1 etch 1720 and P3 etch 1724 are used to isolate battery layers across the substrate 1702 so any non-conductive material suitable for this isolation may be used. In an embodiment, substrate 1702, cathode contact 1704, cathode 1706, electrolyte 1708, anode 1710, anode contact 1712, P1 etch 1720, P2 etch 1722, and/or P3 etch 1724, are the same as or similar to previously described substrate 102, cathode contact 104, cathode 106, electrolyte 108, anode 110, anode contact 112, P1 etch 1020, P2 etch 1022, and/or P3 etch 1024, respectively.

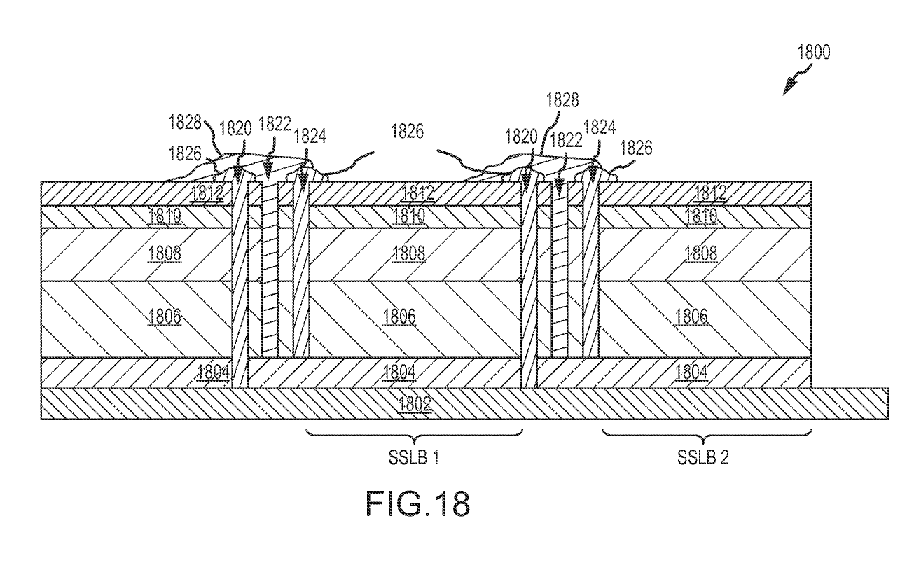

FIG. 18 illustrates an embodiment of a fourth step of a method for fabricating SSLBs 1800. In the fourth step, a conductive material 1828 such as but not limited to a conductive ink is filled into the P2 etch 1822. This conductive material 1828 functions to electrically connect an anode 1810 and/or an anode contact 1812 of one battery with a cathode 1806 and/or cathode contact 1804 of an adjacent battery. It should be noted that the conductive material 1828 overlaps the non-conductive material 1826 in the P1 etch 1820 to contact, in this embodiment, the anode contact 1812. This creates the electrical connection between the anode contact 1812 and the adjacent cathode contact 1804. The conductive material 1828 overlaps the material 1826 in the P1 etch 1820, but not the non-conductive material 1826 in the P3 etch 1824, otherwise the conductive material 1828 in the P2 etch 1822 would short the battery. In an embodiment, substrate 1802, cathode contact 1804, cathode 1806, electrolyte 1808, anode 1810, anode contact 1812, P1 etch 1820, P2 etch 1822, P3 etch 1824, and/or insulating ink 1826, are the same as or similar to previously described substrate 102, cathode contact 104, cathode 106, electrolyte 108, anode 110, anode contact 112, P1 etch 1020, P2 etch 1022, P3 etch 1024, and/or insulating ink 1726, respectively.

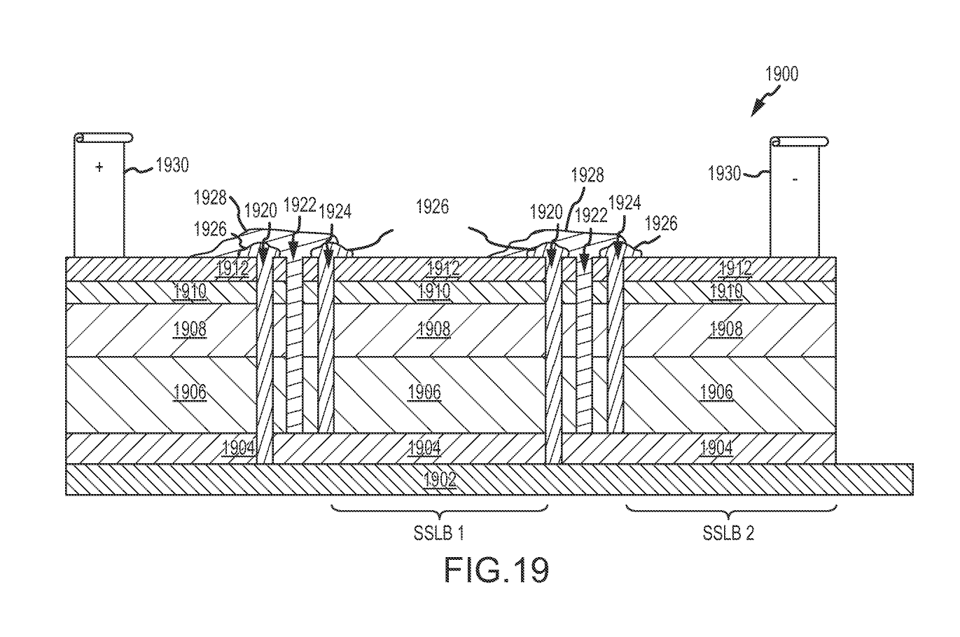

FIG. 19 illustrates an embodiment of a fifth step of a method for fabricating SSLBs 1900. In the fifth step, busbars 1930 are connected to the SSLB in any suitable method. Busbars 1930 can be used as a point of contact for the fabricated SSLB. The size of the busbars 1930 can affect the maximum current that passes through the SSLB. Further FIG. 19 illustrates an embodiment of a completed series connected SSLB. In an embodiment, substrate 1902, cathode contact 1904, cathode 1906, electrolyte 1908, anode 1910, anode contact 1912, P1 etch 1920, P2 etch 1922, P3 etch 1924, insulating ink 1926, and/or conductive material 1928, are the same as or similar to previously described substrate 102, cathode contact 104, cathode 106, electrolyte 108, anode 110, anode contact 112, P1 etch 1020, P2 etch 1022, P3 etch 1024, insulating ink 1726, and/or conductive material 1828, respectively.

FIG. 20 illustrates an embodiment of a completed parallel connected SSLB 2000. The completed parallel connected battery 2000 can be fabricated in a method similar to that shown in FIG. 15 through FIG. 19. The main difference between fabricating a series connected SSLB and a parallel connected SSLB is the order of the P1 2020, P2 2022, and/or P3 2024 etches. When fabricating a series connected SSLB a plurality of P1/P2/P3 etches 2020/2022/2024 are present. Alternately, when fabricating a parallel connected SSLB 2000 at least one set of P1/P2/P3 etches 2020/2022/2024 are present followed by a singular P1 etch 2020 followed by at least one set of P3/P2/P1 etches 2024/2022/2020. In the completed parallel connected SSLB 2000 illustrated, a non-conductive material 2026 fills the P1 2020 and P3 2024 etches while a conductive material 2028 fills the P2 etch 2022. The singular P1 etch 2020 has been filled with a non-conductive material 2026 and a conductive material 2028 has been deposited over and overlaps beyond the non-conductive fill 2026. The overlap of the conductive material 2028 covering the non-conductive fill 2026 of the singular P1 etch 2020, functions to electrically connect the anode contacts 2012 of adjacent batteries. Further, busbars 2030 have been connected to the SSLB and can serve as a point of electrical contact. It should be noted that the SSLB illustrated uses three contact points, one of which is a common ground, while the other two serve as positive contacts for the parallel battery branches. In an embodiment, substrate 2002, cathode contact 2004, cathode 2006, electrolyte 2008, anode 2010, anode contact 2012, P1 etch 2020, P2 etch 2022, P3 etch 2024, insulating ink 2026, conductive material 2028, and/or busbar 2030, are the same as or similar to previously described substrate 102, cathode contact 104, cathode 106, electrolyte 108, anode 110, anode contact 112, P1 etch 1020, P2 etch 1022, P3 etch 1024, insulating ink 1726, conductive material 1828, and/or busbar 1930, respectively.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components and individual functions can be distributed among different components. In this regard, any number of the features of the different embodiments described herein may be combined into one single embodiment and alternate embodiments having fewer than or more than all of the features herein described as possible.

While various embodiments have been described for purposes of this disclosure, various changes and modifications may be made which are well within the scope of the disclosed methods. Numerous other changes may be made which will readily suggest themselves to those skilled in the art and which are encompassed in the spirit of the disclosure.

We claim:

1. A method to maximize energy density of a solid state battery comprising:
depositing a plurality of first battery layers on a first side of a substrate;
depositing a plurality of second battery layers on a second side of the substrate;
connecting a first one of the first battery layers with a first one of the second battery layers; and
connecting a second one of the first battery layers with a second one of the second battery layers.

2. The method of claim 1, wherein both the plurality of first battery layers and the plurality of second battery layers comprise at least one of a cathode contact, a cathode, an electrolyte, an anode, and an anode contact.

3. The method of claim 1, wherein both the first one of the first battery layers and the first one of the second battery layers comprise one of a cathode contact and a cathode.

4. The method of claim 1, wherein both the second one of the first battery layers and the second one of the second battery layers comprise one of an anode contact and an anode.

5. The method of claim 1, wherein connecting comprises one of soldering, wire-bonding, etching at least one via through the substrate, and drilling at least one via through the substrate.

6. A method to maximize energy density of a solid state battery comprising:
depositing a plurality of first battery layers on a first side of a substrate;
depositing a plurality of second battery layers on a second side of the substrate; and
connecting a first one of the first battery layers with a second one of the second battery layers.

7. The method of claim 6, wherein both the plurality of first battery layers and the plurality of second battery layers comprise at least one of a cathode contact, a cathode, an electrolyte, an anode, and an anode contact.

8. The method of claim 6, wherein the first one of the first battery layers comprises one of a cathode contact and a cathode.

9. The method of claim 6, wherein the second one of the second battery layers comprises one of an anode and an anode contact.

10. The method of claim 6, wherein connecting comprises one of soldering, wire-bonding, etching at least one via through the substrate, and drilling at least one via through the substrate.

11. A solid-state battery comprising:
a substrate with at least a first side and a second side;
a first cathode deposited on the first side of the substrate;
a first electrolyte deposited on the first cathode;
a first anode deposited on the first electrolyte;
a second cathode deposited on the second side of the substrate;
a second electrolyte deposited on the second cathode; and
a second anode deposited on the second electrolyte, wherein
at least one of the first cathode and the first anode are in electrical contact with at least one of the second cathode and the second anode.

12. The device of claim 11, wherein the substrate is PET.

13. The device of claim 11, wherein at least one of the first cathode and the second cathode further include a cathode contact.

14. The device of claim 11, wherein at least one of the first cathode and the second cathode comprise at least one of LiCoO₂, LiMn₂O₄, and LiFePO₄.

15. The device of claim 11, wherein at least one of the first anode and the second anode further include an anode contact.

16. The device of claim 11, wherein at least one of the first anode and the second anode comprises lithium.

17. The device of claim 11, wherein at least one of the first electrolyte and the second electrolyte comprises LiPON.
